(19) United States
(12) Patent Application Publication
(10) Pub. No.: US 2011/0270590 A1
(43) Pub. Date: Nov. 3, 2011

(54) NONLINEAR IDENTIFICATION USING COMPRESSED SENSING AND MINIMAL SYSTEM SAMPLING

(75) Inventors: Vladimir Aparin, San Diego, CA (US); Robert P. Gilmore, Poway, CA (US)

(73) Assignee: QUALCOMM INCORPORATED, San Diego, CA (US)

(21) Appl. No.: 12/776,180

(22) Filed: May 7, 2010

Related U.S. Application Data
(60) Provisional application No. 61/328,947, filed on Apr. 28, 2010.
(60) Provisional application No. 61/328,952, filed on Apr. 28, 2010.

(51) Int. Cl. G06F 17/10

(52) U.S. Cl. 703/2

(57) ABSTRACT

Compressed sensing is used to determine a model of a nonlinear system. In one example, L1-norm minimization is used to fit a generic model function to a set of samples thereby obtaining a fitted model. Convex optimization can be used to determine model coefficients that minimize the L1-norm. In one application, the fitted model is used to calibrate a predistorter. In another application, the fitted model function is used to predict future actions of the system. The generic model is made of up of constituent functions that may or may not be orthogonal to one another. In one example, an initial model function of non-orthogonal constituent functions is orthogonalized to generate a generic model function of constituent orthogonal functions. Although the number of samples to which the generic model is fitted can be less than the number of model coefficients, the fitted model nevertheless accurately models system nonlinearities.

### CROSS-REFERENCE TO RELATED APPLICATION

This application claims the benefit under 35 U.S.C. §119 of Provisional Application Ser. No. 61/328,952, filed Apr. 28, 2010, entitled “Method of Identification and Compensation of System Nonlinearities”, by Vladimir Aparin et al., and of Provisional Application Ser. No. 61/328,947, filed Apr. 28, 2010, by Vladimir Aparin et al., entitled “Method of Identification and Compensation of System Nonlinearities”, by Vladimir Aparin et al., said two provisional applications are incorporated herein by reference.

### BACKGROUND INFORMATION

1. Technical Field

The present disclosure relates to modeling nonlinear systems.

2. Background Information

The relationship between changes in the input to a system versus changes in the output of the system may be nonlinear. It is useful in many areas of science and technology to develop a mathematical model of such nonlinear systems. Some examples of systems to be modeled include: an electronic system, a mechanical system, a biological system, a stock market, a human behavior, weather changes, climate changes, and utility usage. A good model that models the nonlinearities of such a system has several uses. For example, such a model may be usable in the linearization of a system by means of predistortion in order to reduce signal distortion. For example, such a model may be usable to predict future outputs of a process by means of model extrapolation.

In the past, nonlinear models were often determined using the following method. First, in this method, a model function (also referred to as a model) is selected. The particular model function selected can be of any complexity (order) and may include special functions and, in some cases, can use information on prior operation of the system or the system's prior behavior. In many cases, the model function is a generic nonlinear representation. An example of a generic nonlinear representation is a power series (for example, Taylor series). Such a nonlinear representation is particularly useful where the system being modeled is to be modeled without the system's memory characteristics being modeled. Other examples of generic nonlinear representations include a Volterra series or one of its truncated versions (for example, a Wiener series, a Hammerstein series, or a memory polynomial). These nonlinear representations are particularly useful where the system being modeled is to be modeled with its memory characteristics. The maximum number of terms in the power or Volterra series is limited by the maximum degree of nonlinearity to be modeled, and in the case of the Volterra series by the maximum memory lag. Table 1 below indicates the number of Volterra series coefficients required as a function of memory length and the degree of the series.

TABLE 1

| Highest Degree of | Number of Coefficients for Different Memory Lengths | | | | |
|---|---|---|---|---|---|
| Nonlinearity | K = 0 | K = 1 | K = 2 | K = 3 | K = 4 |
| 1 | 1 | 2 | 3 | 4 | 5 |
| 3 | 2 | 8 | 21 | 44 | 80 |
| 5 | 3 | 20 | 81 | 244 | 605 |
| 7 | 4 | 40 | 231 | 944 | 3,055 |
| 9 | 5 | 70 | 546 | 2,904 | 11,875 |

Second, a sufficient number of input and output data points are collected (measured). A pair of input and output values is also referred to as a sample. In each such sample data point, the output value y is the measured envelope amplitude of the output of the nonlinear system that the nonlinear system outputs when it is supplied with the input envelope value x as an input. M is the number of coefficients of the model function. N is the number of sample data points.

Third, the coefficients of the selected model function are then fitted to the measured sample data points. An advantage of generic nonlinear model functions such as a power series or a Volterra series is that the output is a linear function of the model coefficients. For instance, in a power series polynomial of the form y=a₁x+a₂x²+a₃x³+ . . . +a_{M}x^{M}, the output value y of the model function is a nonlinear function of the input value x, but at the same time y is a linear function of the power series (model) coefficients a₁, a₂, a₃, . . . . This linear dependence of the model function output on the model coefficients allows the use of the least-squares fitting to find the model function coefficients by minimizing the sum of squared fitting errors (ymodelᵢ-ymeasuredᵢ)² for i=1 . . . N, where N is the number of measured sample data points. Least-squares fitting is also referred to in the art and here as the Least Mean Square error method, or the Least Mean Squares method, or the “LMS method”.

FIG. 1 (Prior Art) is a diagram that illustrates an example of a device 1 that uses the above-described prior art method of determining a nonlinear model. Device 1 includes a radio transmitter 2, a sensing receiver 9, and a predistorter 7. The transmitter 2 includes a Digital-to-Analog Converter (DAC) 3, a Base Band Filter (BBF) 4, an Up Converter (UPC) 5, and a Power Amplifier (PA) 6. A stream of input values x is supplied as an input signal stream to the transmitter. The relationship of input values x to the transmitter to the corresponding output values y of the power amplifier 6 has an undesired nonlinearity. The x=xᵢ+jx_{q} notation used in FIG. 1 to denote the input values x indicates that each value x is a complex number where the real portion indicates an In-Phase signal (I) component and where the imaginary portion indicates a Quadrature phase signal (Q) component. Due to the undesired nonlinearity of the transmitter, the predistorter 7 is provided. Rather than supplying the input values u directly to the DAC 3 of the transmitter 2, the input values u are predistorted into the values x and the x values are supplied to the DAC 3 such that the overall relationship of the input values u to the corresponding output values y from the power amplifier 6 is substantially linear.

In the example of FIG. 1, a generic model function is selected to represent nonlinearities of the system. The system to be modeled in this case is transmitter 2. The model function, as represented by block 8, is of the form y=a₁*x+a₂*x|x|²+a₃*x|x|⁴ . . . a_{M}*x|x|^{2M-2}. The model function therefore is a sum of a set of polynomial functions. The constituent polynomial functions that make up the model function in this particular case are: x, x|x|², x|x|⁴ . . . x|x|^{2M-2}. Multiple instances of the model function equation can be represented in a matrix equation form y=Pa, where matrix P is a Vandermonde matrix P. As illustrated, the rows of the Vandermonde matrix are x, x|x|², x|x|⁴, . . . , x|x|^{2M-2}, where the x value for each row is a different value of x. The numbers in a row of the matrix represent the polynomial functions (that make up the model function) evaluated for the particular value of x.

The output of the system (i.e., transmitter 2) is sampled by the transmitter sensing receiver 9. The system output (at the output of power amplifier 6) is coupled to the input of a Down Converter (DNC) 10. The downconverted output of DNC 10 is filtered by Base Band Filter (BBF) 11, and is digitized by Analog-To-Digital Converter (ADC) 12 into values y. Each sample data point includes an incoming complex x value and its corresponding transmitter complex output value y. The y=yᵢ+jy_{q} notation used in FIG. 1 indicates that each value y is a complex number where the real portion indicates an In-Phase signal (I) component and where the imaginary portion indicates a Quadrature phase signal (Q) component. The value x is a value that represents the envelope of a baseband signal as supplied to the transmitter and the value y is a value that represents the envelope of the corresponding downconverted output signal as supplied back to the predistorter.

The generic model function is then “fitted” to the sampled data points using the Least Mean Squares (LMS) method as represented by block 13. The resulting model coefficients aᵢ (i=1 . . . M) are stored in memory as represented by block 14. For each incoming value u, the equation indicated in block 15 is used to determine a predistorted value x, where the coefficients a, (i=1 . . . M) on the left side of the equation are the model coefficients from the memory and the coefficient b on the right side of the equation is a desired linear gain of the transmitter. Typically, b=a₁.

FIG. 2 (Prior Art) is a high-level diagram of the system of FIG. 1. The predistorter 7 predistorts the incoming values u to generate predistorter output values x, and the predistorted values x are supplied to the nonlinear system 2 (here the transmitter 2 of FIG. 1). Predistorter 7 predistorts the values u into the values x such that the transfer function of the overall system from the inputs u to the outputs y of power amplifier 6 is substantially linear. It is assumed here that sensing receiver 9 does not introduce substantial nonlinearity into the sensing path and therefore that the output of power amplifier 6 is accurately represented in the sensed value y as received back at the sensing input of predistorter 7.

A disadvantage of the method utilized by predistorter 7 of FIG. 1 is that a large number of sample data points must be taken. For the model to be well-fitted, the number of sample data points N should be at least equal to the number of the coefficients M in the model function. Due to this large number of sample data points, a large amount of processing power is required to perform the necessary computations using those sample data points. The necessity of providing powerful computational resources makes it difficult to use the method in a real time application. Moreover, the modeling of the nonlinear system using a model function that models memory of the system (for example, a Volterra series model) is so computationally intensive that carrying out the method in real time may be prohibitively complex and expensive. Another drawback of the method utilized by predistorter 7 of FIG. 1 is that the LMS method is wasteful of computational resources. The LMS method involves solving for all model coefficients in the case of sparse models when only few model coefficients are significant and the rest are zero or are very small. In many cases, it is not known a priori which coefficients will be small or zero. Consequently all coefficients are calculated.

### SUMMARY

A method involves using compressed sensing (also known as compressive sensing or compressive sampling) to determine a fitted model of a nonlinear system. In a first step, a generic model (also referred to as a generic model function) is selected based on characteristics of the input signal x. The generic model function is made up of N constituent functions. The generic model function selected may be a function whose constituent functions are not orthogonal to one another, or the generic model function selected may be a function whose constituent functions are orthogonal to one another. A set of the generic model functions can be represented as a matrix P where the values in each row of the matrix correspond to the constituent functions of an instance of the generic model function, where the constituent functions are evaluated at one x value. There is a separate row in the matrix for each instance of the generic model function evaluated at a different x value. In a second step, a sufficient number N of x-y sample data points is collected (measured), where each x,y sample data point includes the output value y (ymeasured) of the nonlinear system being modeled when the nonlinear system is supplied with the corresponding input value x. The number of measured sample data points N can be less than the number of coefficients M of the generic model function. The x input value for each x-y sample data point is used as the x value in determining the values in a row of the matrix P. In a third step, the generic model is fitted to the set of x,y sample data points by using convex optimization to determine the set of model coefficients with minimum L1-norm (L1-norm minimization). The fitting minimizes the sum of absolute values of the model coefficients according to Equation (1) below:

|a₁|+|a₂|+ . . . +|a_{M}|→min, subject to ymeasured=P*a. (1)

There are multiple ways that the generic model function can be selected. In a first way, the generic model function selected is a function whose constituent functions are not orthogonal to one another. The generic model function is, however, sparse in terms of the coefficients of the constituent functions. The generic model function selected may, for example, have a basis of polynomial functions. In one such case, the generic model function is a power series polynomial of the form y=a₁*x+a₂*x|x|²+a₃*x|x|⁴ . . . a_{M}*x|x|^{2M-2}, where the constituent polynomial functions that make up the generic model function are: x, x|x|², x|x|⁴ . . . x|x|^{2M-2}, and where the model coefficients are: a₁, a₂, a₃ . . . a_{M}.

In a second way, the generic model function selected is a function whose constituent functions are orthogonal to one another. For a uniformly distributed input signal x, the orthogonal functions may be selected to be Legendre polynomials. For a sinusoidal input signal x, the orthogonal functions may be selected to be Chebyshev polynomials. For a Gaussian input signal x, the orthogonal functions may be selected to be Hermite polynomials.

In a third way, the generic model function is determined as follows. An initial model function is selected whose constituent functions are not orthogonal to one another. The initial model function may be a power series polynomial or a Volterra series polynomial. In one specific case, the generic model function is a power series polynomial of the form y=a₁*x+a₂*x|x|²+a₃*x|x|⁴ . . . a_{M}*x|x|^{2M-2}. The non-orthogonal functions that make up the initial model function are presented in the form of a Vandermonde matrix, where the values in a row of the matrix represent the non-orthogonal functions evaluated at one x value. There is a separate row in the matrix for each instance of the initial model function evaluated for a different x value. The matrix equation may be given as y=Pa, where the y is a vector of y values, where a is a vector of model coefficients, and where P is a Vandermonde matrix. Next, the matrix is orthogonalized. QR decomposition may, for example, be used to orthogonalize the constituent non-orthogonal functions so that the result is the generic model function involving constituent orthogonal functions. The Q matrix as generated by the QR decomposition contains orthogonal functions, where each row of the Q matrix represents an instance of the generic model function made up of constituent orthogonal functions evaluated at a different value of x.

This method of using compressed sensing to determine a fitted model function of a nonlinear system is a general purpose method and has broad applicability. Nonlinear systems of many different types can be modeled in this way. Examples of nonlinear systems that can be modeled include, but are not limited to: an electronic system, a mechanical system, a biological system, a stock market, a human behavior, weather changes, climate changes, and utility usage. Depending on the application, the resulting fitted model can be used in different ways in different applications. For example, in one application the fitted model function is usable in the linearization of a system by means of predistortion in order to reduce signal distortion. The structure of the conventional adaptive predistorter of FIG. 1 can be employed, except that rather than using an LMS method in block 13 to solve for the model coefficients a, a compressed sensing method involving L1-norm minimization is used in block 13 to solve for the model coefficients a. In another application, a fitted model function as determined by the compressed sensing method is usable to predict future actions of the system by means of model extrapolation.

The foregoing is a summary and thus contains, by necessity, simplifications, generalizations and omissions of detail; consequently, those skilled in the art will appreciate that the summary is illustrative only and does not purport to be limiting in any way. Other aspects, inventive features, and advantages of the devices and/or processes described herein, as defined solely by the claims, will become apparent in the non-limiting detailed description set forth herein.

### BRIEF DESCRIPTION OF THE DRAWINGS

FIG. 1 (Prior Art) is a diagram of a device, where the device includes a predistorter 7 that models a nonlinear system 2 using a conventional LMS method.

FIG. 2 (Prior Art) is a diagram that represents the high-level operation of the predistorter of FIG. 1 and how predistortion is used to cancel nonlinearities in a system.

FIG. 3 is a flowchart of a compressed sensing method 100 of modeling a nonlinear system in accordance with one novel aspect.

FIG. 4 is a diagram of a device, where the device includes a predistorter 202 that models a nonlinear system 201 using the compressed sensing method of FIG. 3.

FIG. 5 is a diagram that illustrates the transfer function of a nonlinear system to be modeled in an undersampled situation.

FIG. 6 is a chart that compares the result of using the LMS method versus the result of using the method 100 of FIG. 3 in the undersampled situation of FIG. 5.

FIG. 7 shows the linearized characteristic of the transmitter by using the LMS method of FIG. 1 and the compressed sensing method of FIG. 3.

### DETAILED DESCRIPTION

FIG. 3 is a flowchart of a method 100 in accordance with one novel aspect. In step 101 of FIG. 3, a generic model (also referred to as a generic model function) is determined where nonlinearities of a system are represented by constituent functions. Statistical properties of an input signal x to be supplied to the system may be used to determine the most appropriate type of generic model function. Different types of generic model functions are better suited to modeling systems where the systems are processing different kinds of input signals x.

There are several ways to determine the generic model function. There are multiple ways of selecting the generic model function. In a first way, the generic model function selected is a function whose constituent functions are not orthogonal to one another. The generic model function is, however, sparse in terms of the coefficients of the constituent functions. The generic model function selected may, for example, have a basis of polynomial functions. In one such case, the generic model function is a power series polynomial of the form y=a₁*x+a₂*x|x|²+a₃*x|x|⁴ . . . a_{M}*x|x|^{2M-2}, where the constituent polynomial functions that make up the generic model function are: x, x|x|², x|x|⁴ . . . x|x|^{2M-2}, and where the model coefficients are: a₁, a₂, a₃ . . . a_{M}.

In a second way, the generic model function selected is a function whose constituent functions are orthogonal to one another. For a uniformly distributed signal x, the orthogonal functions may be selected to be Legendre polynomials. For a sinusoidal signal x, the orthogonal functions may be selected to be Chebyshev polynomials. For a Gaussian signal x, the orthogonal functions may be selected to be Hermite polynomials.

In a third way, the generic model function is determined as follows. An initial model function is selected whose constituent functions are not orthogonal to one another. The initial model function may be a power series polynomial or a Volterra series polynomial. The non-orthogonal constituent functions that make up the initial model function are presented in the form of a Vandermonde matrix, where the values in a row of the matrix represent the non-orthogonal functions evaluated at one x value. There is a separate row in the matrix for each instance of the initial model function evaluated for a different x value. Next, the basis of this matrix is orthogonalized. QR decomposition may, for example, be used to orthogonalize the constituent non-orthogonal functions so that the result is the generic model function involving constituent orthogonal functions. The Q matrix as generated by the QR decomposition contains orthogonal functions, where each row of the Q matrix represents an instance of the generic model function made up of orthogonal constituent functions evaluated at a different value of x.

Once the generic model function is determined, a set of instances of the generic model function can be presented as a matrix equation of the form y=Pa, where y is a vector of y values, where a is a vector of model coefficients, and where P is a matrix. Each column of the matrix P represents one of the constituent functions. Each row of the matrix P corresponds to one instance of the generic model function where each of the constituent functions is evaluated at one particular x value.

In step 102 of the method 100 of FIG. 3, a set of x-y sample points is collected. In each x-y sample point, the y value represents the output of the system to be modeled when the x value of the sample is supplied as an input to the system. The x and y values may be real values in some examples of the method. The x and y values may be complex values other examples of the method. In one advantageous aspect, due to the application of compressed sensing, the number of measured sample data points N can be less than the number M of model coefficients a in the generic model function.

There are multiple ways that the x,y sample data points can be collected or obtained. Y values may be obtained by supplying the system with single-tone excitations and measuring the envelope amplitude of the input sinusoid (an x value) versus the envelope amplitude of the output sinusoid (a y value). Alternatively, samples may be taken by envelope sampling of the output of the system when the system is in actual use and associating the output y envelope samples with the corresponding system input x envelope values. The samples may be taken by taking the system out of use, and entering a calibration mode, and taking the samples in the calibration mode, and then returning the system to normal operation. Alternatively, the samples can be taken on-the-fly over time during normal operation of the system using the output envelope sampling technique without putting the system into a special calibration mode.

In a step 103 of method 100 of FIG. 3, the model coefficients aᵢ (i=1 . . . M) of the generic model function are then determined so that the generic model function is “fitted” to the measured sample data points. This fitting can be done by using convex optimization to determine the set of model coefficients a, (i=1 . . . M) with minimum L1-norm (L1-norm minimization). The fitting minimizes the sum of absolute values of model coefficients: |a₁|+|a₂|+ . . . +|a_{M}|→min, subject to ymeasured=P*a.

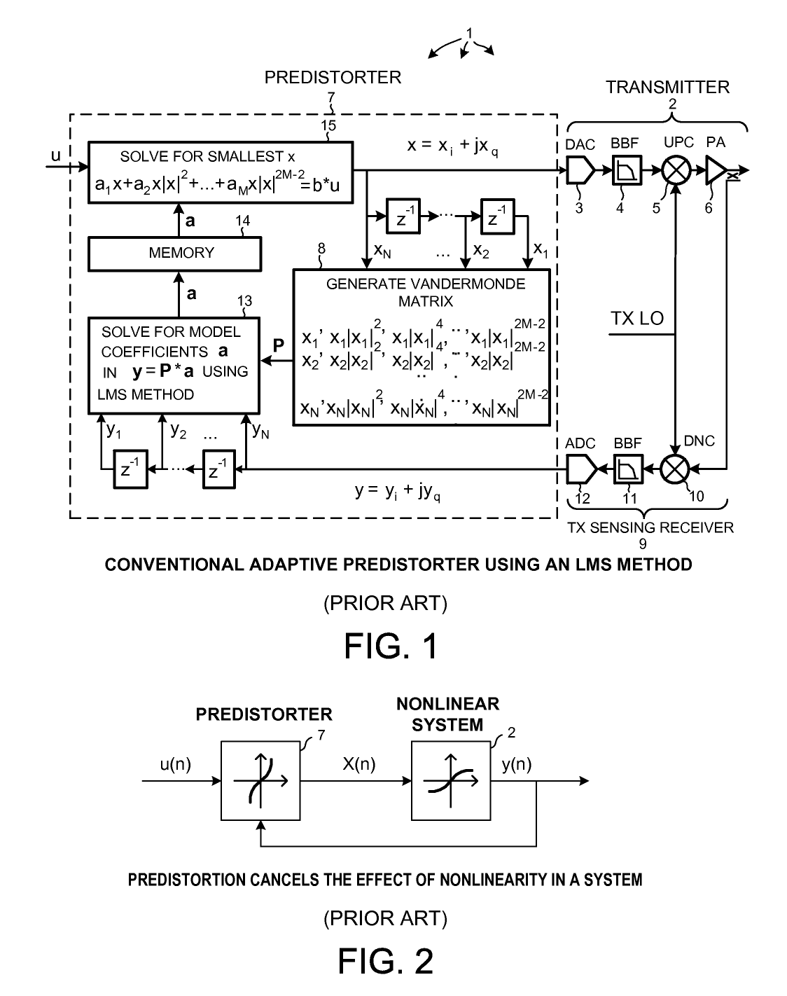

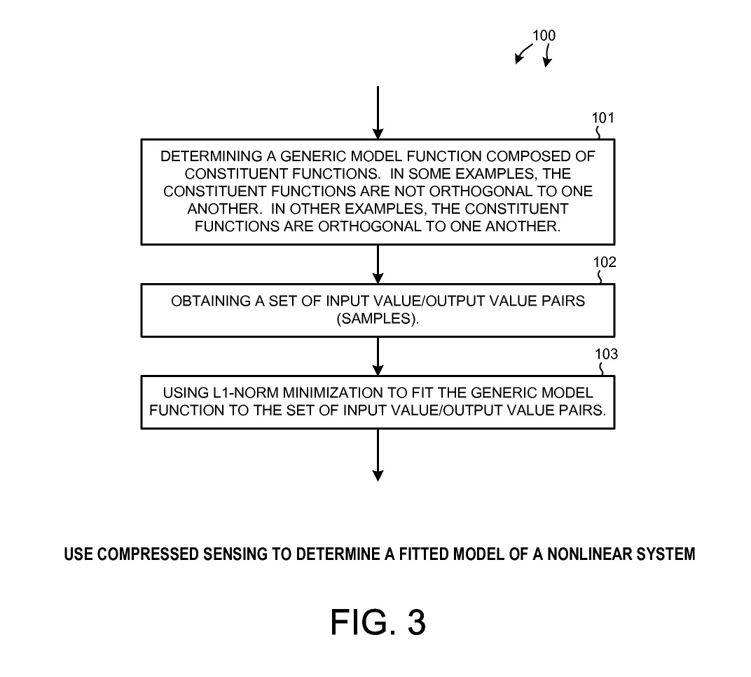

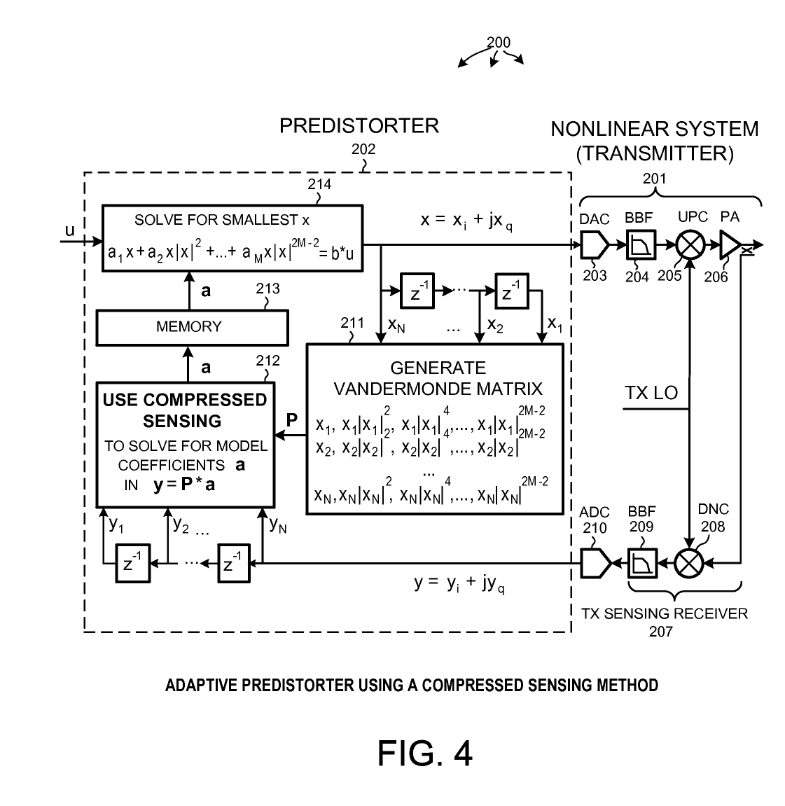

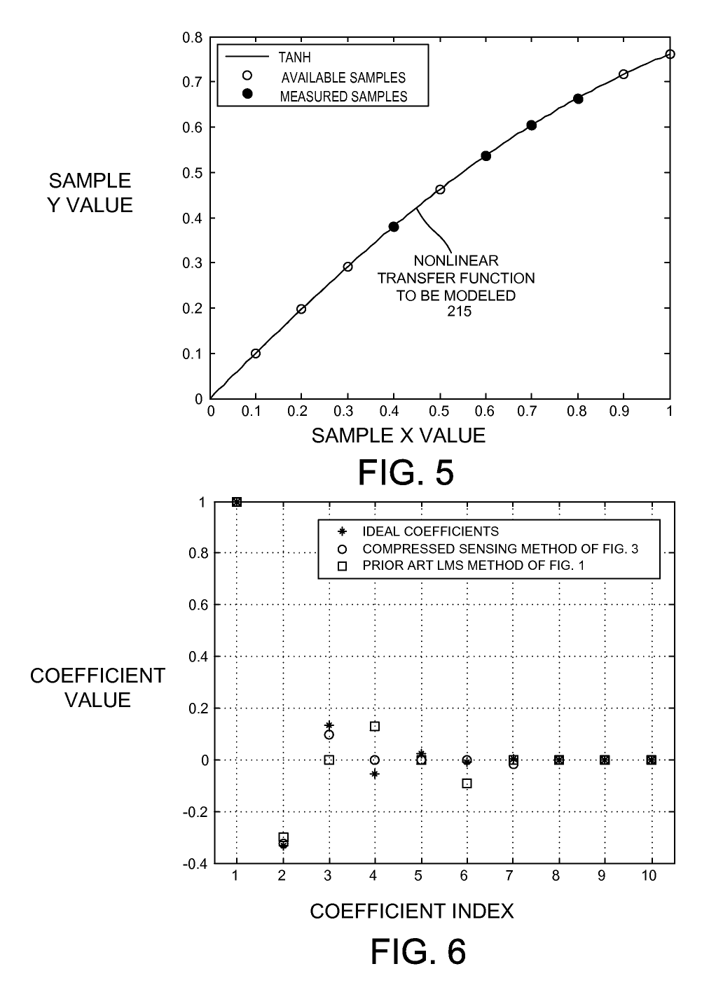

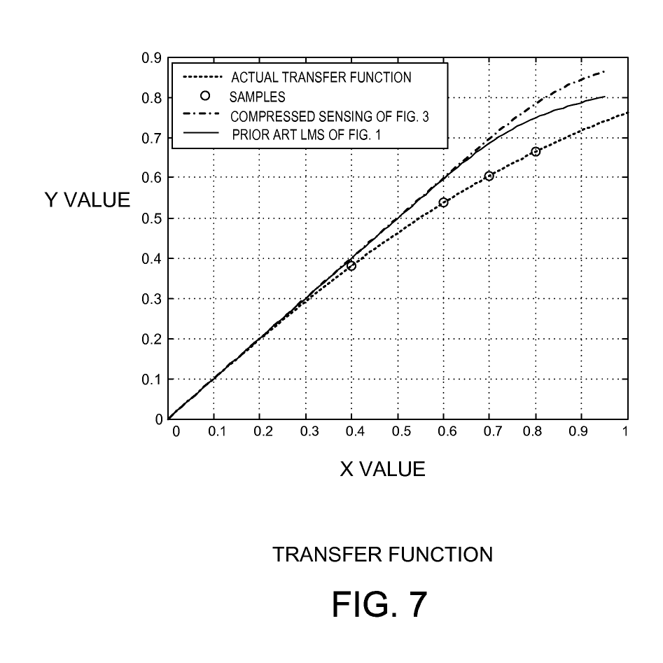

The use of compressed sensing in the method 100 of FIG. 3 automatically finds the most significant model function coefficients and keeps the rest at zero. Compressed sensing is efficient in terms of the required number of samples that need to be taken to accurately fit the model. Whereas using the LMS method conventionally used to fit a model to a set of samples as in the prior art of FIG. 1 requires taking at least as many sample data points as there are model coefficients, the use of compressed sensing in the novel method 100 of FIG. 3 accurately fits the generic model function to a smaller number of less than M sample data points. Less output sampling, and less associated computation, is therefore necessary to model the nonlinear system using the novel method 100 of FIG. 3.

Nonlinear systems of numerous different types can be modeled in this way. Examples of such systems include, but are not limited to: an electronic system, a mechanical system, a biological system, a stock market, a human behavior, weather changes, climate changes, and utility usage. The resulting fitted model (also referred to as a fitted model function) that models the nonlinear system has many uses. For example, the fitted model function may be usable in the linearization of a system by means of predistortion in order to reduce signal distortion. For example, the fitted model function may be usable to predict future actions of the system by means of model extrapolation.

FIG. 4 is a diagram that illustrates an example of one particular use of the broadly applicable general method 100 of FIG. 3. Although the example of FIG. 4 involves the electronic arts, and more particularly involves linearizing the effects of a nonlinear transmitter circuit, it is to be understood that the method 100 of FIG. 3 is not limited to use in the electronic arts. The circuit 200 of FIG. 4 includes a radio transmitter 201 that exhibits nonlinearity. Transmitter 201 is therefore also referred to here as the “nonlinear system” because it is this transmitter that is being modeled using the general method 100 of FIG. 3. The resulting fitted model function is then used to calibrate an adaptive predistorter 202 that compensates for the nonlinearity. Adaptive predistorter 202 can for example be implemented in a digital baseband processor integrated circuit of a cellular telephone handset in software, in firmware, or in hardware, or in various combinations of these. Nonlinear system 201 includes a Digital-to-Analog Converter (DAC) 203, a Base Band Filter (BBF) 204, an Up Converter (UPC) 205, and a Power Amplifier (PA) 206. The relationship of inputs x to the corresponding outputs y of the power amplifier 206 has the undesired nonlinearity. The x=xᵢ+jx_{q} notation used in FIG. 4 indicates that each value x is a complex digital number where the real portion represents an In-Phase signal (I) component and where the imaginary portion represents a Quadrature phase signal (Q) component. Similarly, the y=yᵢ+jy_{q} notation indicates that each value y is a complex digital number where the real portion represents an In-Phase signal (I) component and where the imaginary portion represents a Quadrature phase signal (Q) component.

Adaptive predistorter 202, rather than supplying the input values u directly to DAC 203 of transmitter 201, predistorts the complex input values u into the values x such that the overall relationship of the values u to the corresponding output values y of power amplifier 206 is substantially linear. The output values y are determined (for example, are sampled or measured) by coupling the output of power amplifier 206 to the input of a “transmitter sensing receiver” 207. The transmitter sensing receiver 207 downconverts the power amplifier output signal down to baseband frequency and then digitizes the amplitude of the complex envelope of the downconverted signal. Transmitter sensing receiver 207 includes a Down Converter (DNC) 208, a Base Band Filter (BBF) 209, and an Analog-to-Digital Converter (ADC) 210. The complex envelope of the downconverted signal is sampled at a number of different times by ADC 210, thereby generating a set of sample x-y data points. The x values of these points represent baseband envelope input values and are denoted x₁, x₂ . . . x_{N}. The y values of these x,y sample data points represent baseband envelope output values and are denoted y₁, y₂ . . . y_{N}.

As represented by block 211, a generic model function is determined. The generic model function is made up of constituent functions. In the specific example set forth in FIG. 4, the generic model function is a power series whose constituent functions are polynomials. A set of these generic model functions can be represented by the matrix equation y=Pa, where P is a Vandermonde matrix. In the matrix P, each row of values represents the polynomial functions of one instance of the generic model function evaluated for one specific x value. There is one row in the P matrix for each different value of x. Each column in the P matrix corresponds to a different one of the constituent polynomials. M is the number of coefficients in the generic model function. N is the number of sample data points to be taken. The values of the Vandermonde matrix P are set forth in block 211 of FIG. 4.

As represented by block 212, compressed sensing is used to fit the generic model function to the set of x,y sample points. In the specific example set forth in FIG. 4, this is done by finding the set of model coefficients with minimum L1-norm (the sum of |a₁|+|a₂|+ . . . +|aₘ| is minimized) subject to ymeasured=P*a. A convex optimization algorithm may be used to solve the L1-norm minimization problem to find the model coefficients aᵢ (i=1 . . . M). The coefficients aᵢ (i=1 . . . M) are complex, i.e. they account for both AM-AM and AM-PM conversions. The determined model coefficients a, (i=1 . . . M) are then stored in a memory 213 and the sensing receiver feedback path through sensing receiver 207 is disabled. (According to the notation used here, all ai's are “odd” in a sense that they stand in front of the odd-order nonlinearities x, x|x|², x|x|⁴ . . . x|x|^{2M-2}, where in an odd-order nonlinearity the total power of x is odd). The previously used model coefficients aᵢ (i=1 . . . M) used in block 214 are replaced with the newly determined coefficients a, (i=1 . . . M) from memory 213. At this point the predistorter 202 can be said to have been recalibrated in an adaptive coefficient update step.

Subsequently and during normal circuit operation, as represented by block 214, for each incoming baseband input value u the corresponding predistorter output value x is determined by solving Equation (2) below for x:

a₁*x+a₂*x|x|²+a₃*x|x|⁴ . . . a_{M}*x|x|x|^{2M-2}=b*u (2)

where b is a desired linear gain of the transmitter, typically b=a₁. In some examples, a lookup table (LUT) is used (to convert an incoming u value into a corresponding predistorted x value) rather than performing computations to solve an equation such as Equation (2) for each incoming u value.

The functional components of predistorter 202 as illustrated in FIG. 4 may, for example, be implemented in software or firmware in the digital baseband integrated circuit of a cellular telephone handset where the software or firmware is executed by a processor in the integrated circuit. Specialized hardware may be provided to accelerate portions of the computations involved. Predistorter 202 may be recalibrated periodically on-the-fly, as the cellular telephone handset is being used by an end-user in the field, by taking a number of sample data points and then using these sample data points to determine a new set of model coefficients a, (i=1 . . . M). Due to the use of compressed sensing, the number of sample data points that must be taken into order to recalibrate the predistorter adequately well is less than the number of model function coefficients M. As a result, the amount of computation required to fit the model is substantially less that the computation that would otherwise be required were the conventional predistorter 7 of FIG. 1 being used. The reduced amount of computation makes it practical and economically realistic to perform in-the-field recalibration of the predistorter of a cellular telephone handset transmitter. The recalibration can also be done periodically in a background when the cellular telephone is not being used and when computational demands on the processor of the digital baseband integrated circuit are minimal. Where transmitter nonlinearity changes over time such as due to changes in operating frequency, temperature and supply voltage changes and/or due to transistor aging, the predistorter is recalibrated in the field. The predistorter is recalibrated in this way throughout the lifetime of the device so that it better counteracts changing transmitter nonlinearities over time. In one example, the cellular telephone automatically enters an on-to-fly recalibration mode when needed, such as for example when a strong TX signal distortion is detected that indicates a deviation of the previously fitted model from the current transmitter characteristics.

In another example, the calculating of coefficients is not done on the cellular telephone, but rather sample points are collected on the cellular telephone and are periodically sent from the cellular telephone to a base station where another processor does the calculating and then the base station sends back the determined coefficients to use to the cellular telephone. The cellular telephone receives the determined coefficients and uses them to recalibrate the predistorter of the cellular telephone.

The amount a predistorter can reduce distortion is generally limited to about 10 dB where the model used to model the system is memoryless. In one example, rather that using a memoryless generic model function (for example, a power series), the generic model function is a function that models system memory (for example, a Volterra series). As a result, the generic model function as fitted to the sampled data points models memory effects of the system and allows the predistorter to reduce distortion by approximately 15-20 dB. By further reducing distortion in this way, a more power-efficient power amplifier can be used (a power amplifier that is very power-efficient but that is very nonlinear) that reduces power consumption of the overall device without adversely affecting performance.

$$y ( n ) = {\sum }_{k = 0}^{K} {a}_{1} ( k ) x ( \begin{matrix}n & k\end{matrix} ) + {\sum }_{{k}_{1} = 0}^{K} {\sum }_{{k}_{2} = {k}_{1}}^{K} {\sum }_{{k}_{3} = 0}^{K} {a}_{3} ( {k}_{1} , {k}_{2} , {k}_{3} ) x ( n - {k}_{1} ) x ( n - {k}_{2} ) x ( n - {k}_{3} ) + … \qquad ( 3 )$$

If the Volterra function of Equation (3) above is used for the generic model function using even a modest highest degree of nonlinearity, then the number of model coefficients is seen to increase rapidly as a function of the amount of memory length K. For example, as indicated in Table 1, if a nonlinearity degree of nine is to be modeled (2M−1=9 in Table 1), and if a memory length of two is to be modeled (K=2 in Table 1), then the number of model coefficients in the model function is 546. A memory length of two indicates that the current model function output y(n) is a function of not only the current x(n) input value, but also is a function of the two preceding x input values x(n−1) and x(n−2). The LMS method of FIG. 1 requires the number of sample data points to exceed the number of model coefficients. A prohibitively large number of sample data points would therefore have to be taken to solve for the model coefficients using the LMS method. Moreover, the LMS method of FIG. 1 involves solving for all model coefficients even if some of those coefficients might be small or zero. Performing all the necessary computations may consume an undesirable amount of power if such a method were to be implemented in a handheld device such as a cellular telephone. The use of compressed sensing in the method 100 of FIG. 3, in contrast, uses L1-norm minimization and only requires a relatively small number of sample data points. Moreover, the method 100 of FIG. 3 uses compressed sensing and does not solve for coefficients that are zero or very small. The method therefore makes modeling a nonlinear system with memory practical in a cost-sensitive handheld consumer device such as a cellular telephone.

FIG. 5 is a diagram that illustrates a nonlinear transfer function 215 to be modeled in an undersampled situation. The filled dark circles indicate four random sample data points to be taken. From these four sample data points, both the LMS method and the compressed sampling method 100 of FIG. 3 were used to calculate ten coefficient values a so as to match a generic model function to the transfer function 215.

FIG. 6 is a chart that compares the result of using the LMS method versus the result of using the method 100 of FIG. 3. The horizontal axis of the chart indicates the index of the coefficient a. Accordingly, there are ten coefficients a₁, a₃, a₅ . . . a₁₀. The vertical axis of the chart indicates the value of each of the coefficients. The star symbols appearing in the chart represent the correct coefficient values. The square symbols appearing in the chart represent the results of using the LMS method. There is significant deviation between the coefficient values as determined by the LMS method and the correct coefficient values represented by the star symbols. The reason is that in order for the LMS method to extract the ten coefficients accurately, the LMS method requires ten sample data points be taken and used. In the example of FIG. 5 and FIG. 6, however, only four sample data points were taken (indicated by the dark circles in FIG. 5). The LMS method therefore does a poor job of fitting the model to the true transfer function. In the chart of FIG. 6, the circle symbols indicate the results of using the compressed sampling method 100 of FIG. 3. Note that the circles are much closer to the ten ideal coefficient values even when the transfer function is undersampled as indicated in FIG. 5.

FIG. 7 shows the linearized characteristic of the transmitter by using the LMS method of FIG. 1 and the compressed sensing method of FIG. 3. As can be seen, the compressed sensing method results in a much wider range of linearization than the LMS method.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In one specific example, predistorter 202 of FIG. 4 is implemented in software or firmware. A cellular telephone handset (a specific example of an apparatus) includes a digital baseband processor integrated circuit and a Radio Frequency (RF) transceiver integrated circuit. A processor within the digital baseband processor integrated circuit includes and/or interacts with an amount of semiconductor memory (for example, memory 213). A set of processor-executable instructions (also referred to as code) is stored in this memory. When this processor executes these instructions, it causes the steps of method 100 of FIG. 3 to be carried out. This processor determines the set of model coefficients using compressed sensing by fitting a generic model to a set of sample data points as described above. DAC 203 and ADC 210 of FIG. 4 are parts of the digital baseband processor integrated circuit, whereas the remainder of the nonlinear transmitter 201 and TX sensing receiver 207 is part of the RF transceiver integrated circuit. The blocks within block 202 of FIG. 4 and DAC 203 and ADC 210, except for block 213, represent functions occurring in the digital baseband processor integrated circuit as controlled by the processor that executes the set of processor-executable instructions. For additional information on methods and apparatuses involving the use compressed sensing to fit a generic model to a set of sample data points to determine a fitted model of a nonlinear system, and for additional information on usages of the results of such methods, see: 1) U.S. Provisional Application Ser. No. 61/328,952, filed Apr. 28, 2010, by Vladimir Aparin et al., entitled “Method of Identification and Compensation of System Nonlinearities”, and 2) U.S. Provisional Application Ser. No. 61/328,947, filed Apr. 28, 2010, by Vladimir Aparin et al., entitled “Method of Identification and Compensation of System Nonlinearities” (the entire subject matter of both these provisional applications is incorporated by reference herein).

Although certain specific embodiments are described above for instructional purposes, the teachings of this patent document have general applicability and are not limited to the specific embodiments described above. Accordingly, various modifications, adaptations, and combinations of the various features of the described specific embodiments can be practiced without departing from the scope of the claims that are set forth below.

What is claimed is:

1. A method comprising:
(a) using compressed sensing to determine a fitted model of a nonlinear system.

2. The method of claim 1, wherein L1-norm minimization is used to fit a generic model to a set of input value/output value pairs and thereby determining the fitted model, wherein an output value of one of the input value/output value pairs represents an output of the nonlinear system when the nonlinear system is being supplied with an input value of said one of the input value/output value pairs.

3. The method of claim 1, wherein the fitted model is determined in (a) by:
(a1) determining a generic model of constituent functions;
(a2) obtaining a set of input value/output value pairs, wherein an output value of an input value/output value pair is a value output by the nonlinear system in response to an input value of the input value/output value pair being supplied as an input to the nonlinear system; and
(a3) using L1-norm minimization to fit the generic model determined in (a1) to the obtained set of input value/output value pairs and thereby determining the fitted model of (a).

4. The method of claim 3, wherein the constituent functions of the generic model of (a1) are not orthogonal to one another.

5. The method of claim 3, wherein the constituent functions of the generic model of (a1) are orthogonal to one another.

6. The method of claim 1, wherein the determining of the fitted model of (a) involves:
(a1) presenting multiple instances of a generic model function in a matrix equation form y=Pa, wherein y is a set of output values, wherein a is a set of model coefficients, wherein P is a matrix having multiple rows, wherein the generic model function is made up of a plurality of constituent functions, wherein the constituent functions are not orthogonal to one another, and wherein each row of the matrix P represents the constituent functions of an instance of the generic model function evaluated for a different corresponding value of input value x; and
(a2) obtaining a plurality of x,y samples; and
(a3) using L1-norm minimization to fit the generic model function to the plurality of samples.

7. The method of claim 6, wherein the presenting (a1) is a storing of the multiple instances of the generic model function in a memory, wherein the x and y values of each x,y sample are envelope amplitude values, and wherein a digital processor performs the step (a3) of using L1-norm minimization to fit the generic model function to the plurality of samples.

8. The method of claim 1, wherein the determining of the fitted model of (a) involves:
(a1) presenting multiple instances of a generic model function in a matrix equation form y=Pa, wherein y is a set of output values, wherein a is a set of model coefficients, wherein P is a matrix having multiple rows, wherein the generic model function is made up of a plurality of constituent functions, wherein the constituent functions are orthogonal to one another, and wherein each row of the matrix P represents the constituent functions of an instance of the generic model function evaluated for a different corresponding value of input value x; and
(a2) obtaining a plurality of x,y samples; and
(a3) using L1-norm minimization to fit the generic model function to the plurality of samples.

9. The method of claim 8, wherein the presenting (a1) is a storing of the multiple instances of the generic model function in a memory, wherein the x and y values of each x,y sample are envelope amplitude values, and wherein a digital processor performs the step (a3) of using L1-norm minimization to fit the generic model function to the plurality of samples.

10. The method of claim 1, wherein the determining of the fitted model in (a) involves:
determining an initial model function that is made up of constituent functions, wherein the constituent functions are not orthogonal to one another;
orthogonalizing constituent functions of the initial model function and thereby generating a generic model of orthogonal functions; and
using L1-norm minimization to fit the generic model of orthogonal functions to a set of sample points thereby determining said fitted model of the nonlinear system.

11. The method of claim 1, wherein the fitted model is a model that models memory effects in the nonlinear system.

12. The method of claim 2, wherein the generic model is a Volterra series.

13. The method of claim 2, wherein the generic model includes M constituent functions, and wherein there are N input value/output value pairs in the set of input value/output value pairs, and wherein N is less than M.

14. The method of claim 1, further comprising:
(b) determining a predistortion transfer function from the fitted model determined in (a).

15. The method of claim 14, further comprising:
(c) using the predistortion transfer function determined in (b) to generate a predistorted input value; and
(d) supplying the predistorted input value as an input to the nonlinear system.

16. The method of claim 1, wherein the determining of the fitted model in (a) involves determining a set of model coefficients for the fitted model, wherein the method further comprises:
(b) using the set of model coefficients to calibrate a predistorter.

17. The method of claim 1, wherein the nonlinear system is taken from the group consisting of: an electronic system, a mechanical system, a biological system, a stock market, a human behavior, weather changes, climate changes, and utility consumption.

18. An apparatus comprising:
a processing circuit that determines a set of model coefficients using compressed sensing by fitting a generic model to a set of sample data points using L1-norm minimization.

19. The apparatus of claim 18, wherein the generic model is made up of a plurality of constituent orthogonal functions, and wherein each of the sample data points is obtained by supplying a nonlinear system with an input value of the sample data point and sampling an output of the nonlinear system and thereby obtaining an output value of the sample data point.

20. The apparatus of claim 18, wherein the generic model is made up of a plurality of constituent functions that are not orthogonal to one another, and wherein each of the sample data points is obtained by supplying a nonlinear system with an input value of the sample data point and sampling an output of the nonlinear system and thereby obtaining an output value of the sample data point.

21. The apparatus of claim 18, further comprising:
a nonlinear system, wherein the processing circuit uses the set of model coefficients to generate a corresponding set of predistorter coefficients; and
a predistorter that uses the predistorter coefficients to predistort a first signal and thereby to generate a second signal, wherein the second signal is supplied as an input signal to the nonlinear system.

22. The apparatus of claim 18, wherein the apparatus is a wireless communication device comprising a digital baseband processor and a Radio Frequency (RF) transceiver, wherein the processing circuit is a part of the digital baseband processor.

23. The apparatus of claim 18, wherein prior to said fitting the processing circuit determines the generic model by orthogonalizing an initial model, wherein the initial model is made up of constituent functions that are not orthogonal to one another.

24. The apparatus of claim 18, wherein the generic model is a Volterra function.

25. The apparatus of claim 18, wherein the generic model models memory effects in the nonlinear system.

26. The apparatus of claim 18, wherein the generic model is a power series polynomial.

27. An apparatus comprising:
means for determining a set of model coefficients using compressed sensing by fitting a generic model to a set of sample data points using L1-norm minimization; and
a memory that stores the model coefficients.

28. The apparatus of claim 27, wherein the generic model is made up of a plurality of constituent functions that are orthogonal to one another.

29. The apparatus of claim 27, wherein the generic model is made up of a plurality of constituent functions that are not orthogonal to one another.

30. The apparatus of claim 27, wherein the apparatus is a wireless communication device comprising a digital baseband processor and a Radio Frequency (RF) transceiver, wherein the means and the memory are parts of the digital baseband processor.

31. The apparatus of claim 30, wherein each of the sample data points is obtained by supplying a nonlinear system with an input value of the sample data point and measuring an output of the nonlinear system and thereby obtaining an output value of the sample data point, and wherein the nonlinear system is a part of the RF transceiver.

32. The apparatus of claim 27, wherein the means is also for determining the generic model by orthogonalizing an initial model, wherein the initial model is made up of constituent functions, and wherein the constituent functions of the initial model are not orthogonal to one another.

33. A method comprising:
(a) obtaining a number of samples, wherein the samples are indicative of an operation of a nonlinear system;
(b) using L1-norm minimization to fit a generic model to the samples and thereby obtaining a fitted model having a set of model coefficients;
(c) using the set of model coefficients to calibrate a predistorter; and
(d) using the predistorter to predistort an input signal and thereby to generate a predistorted signal, wherein the predistorted signal is supplied to the nonlinear system, wherein (a) through (d) are performed by a mobile radio communication device.

34. A computer product, comprising:
computer-readable medium comprising:
code for using compressed sensing to determine a fitted model of a nonlinear system.

35. The computer product of claim 34, wherein the code for using compressed sensing determines the fitted model by using L1-norm minimization to fit a generic model to a set of samples thereby determining the fitted model.

36. The computer product of claim 35, wherein the generic model is made up of a plurality of constituent functions, and wherein the constituent functions are not orthogonal to one another.

37. The computer product of claim 35, wherein the generic model is made up of a plurality of constituent functions, and wherein the constituent functions are orthogonal to one another.
